(19) United States
(12) Patent Application Publication
(10) Pub. No.: US 2010/0259476 A1
(43) Pub. Date: Oct. 14, 2010

(54) PRESENTATION CONTROLLING SYSTEM AND PRESENTATION SYSTEM HAVING SAME

(75) Inventor: WEI LI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/494,307

(22) Filed: Jun. 30, 2009

(30) Foreign Application Priority Data
Apr. 9, 2009 (CN) 200910301453.7

(51) Int. Cl. G06F 3/033; G06K 9/00

(52) U.S. Cl. 345/157; 382/181

(57) ABSTRACT

A presentation controlling system is provided for controlling a cursor of a computer. The computer includes a display screen to display the cursor and is configured to output an image to a projector. The projector is configured to project the image onto a projection panel. The presentation controlling system includes a control device, an image processing module, and a cursor controlling module. The control device is configured to project an indicator onto an area occupied by the projected image on the projection panel. The image processing module is configured to recognize the projected indicator, and to track the projected indicator on the occupied area. The cursor controlling module is configured to control movement of the cursor on the display screen according to a track of the indicator on the occupied area, and to activate a cursor action according to the recognized indicator.

### BACKGROUND

1. Technical Field

The present disclosure relates to presentation technology, and particularly, to a presentation controlling system and a presentation system having the same.

2. Description of Related Art

During a presentation, a projector and a computer are used. Presentation content is transmitted from the computer to the projector and then is projected by the projector onto a projection panel. A presenter, usually also a controller, has to present next to the projection panel and control the computer to go with the presentation. However, the projection panel is usually far away from the projector and the computer. This is inconvenient when the presenter moves from the projection panel to the computer, and back to the projection panel.

Therefore, what is needed is to provide a presentation controlling system and a presentation system having the same to overcome the above shortcomings.

### BRIEF DESCRIPTION OF THE DRAWINGS

FIG. 1 is a functional block diagram of a presentation system including a control device, according to an exemplary embodiment.

FIG. 2 is a schematic view of the control device of the presentation system of FIG. 1.

### DETAILED DESCRIPTION

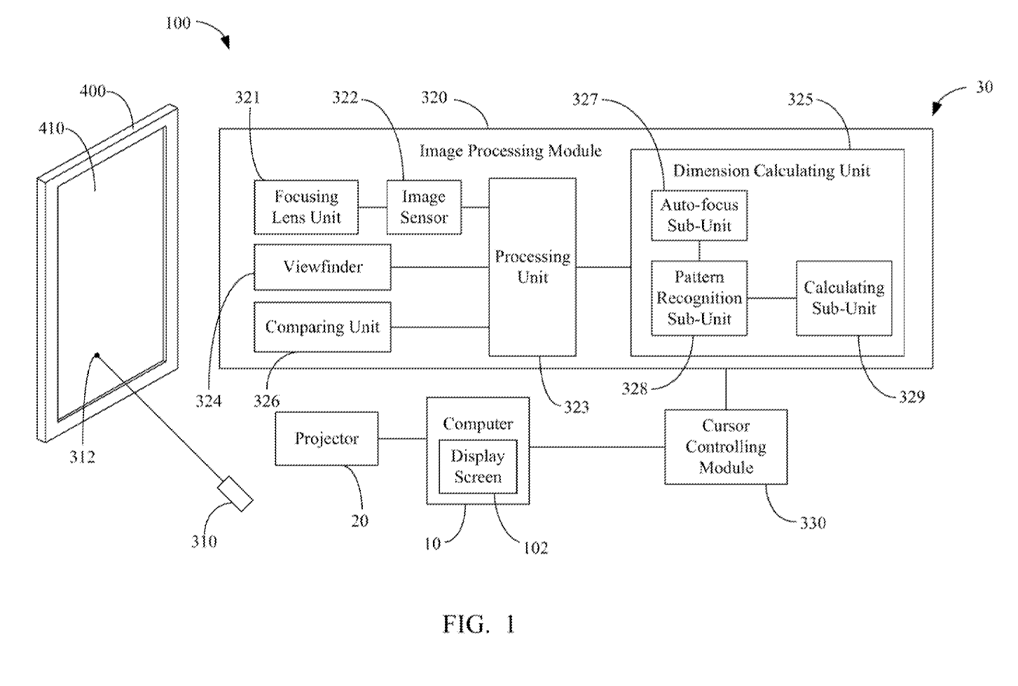

Referring to FIG. 1, a presentation system 100, according to an exemplary embodiment includes a computer 10, a projector 20, and a presentation controlling system 30.

The computer 10 is configured to output an image. The computer 10 includes a display screen 102 and a cursor displayed on the display screen 102. The image is also displayed on the display screen 102. The image may be downloaded from websites, stored in the computer or transferred from external devices. The display screen 102 may be a liquid crystal display, an organic light emitting diode display, or a cathode ray tube display, etc.

The projector 20 is configured to project the image outputted by the computer 10 onto a projection panel 400. The projector 20 may be a digital light processing projector, a liquid crystal on silicon projector or a liquid crystal display projector.

The presentation controlling system 30 includes a control device 310, an image processing module 320, and a cursor controlling module 330.

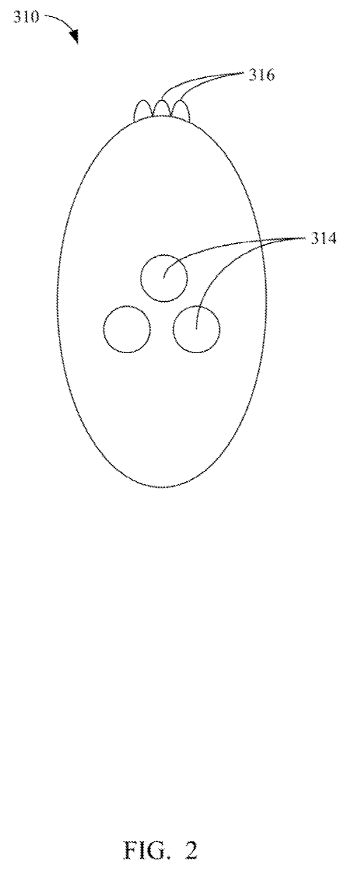

The control device 310 may be manually controlled during a presentation using the system 100. The control device 310 is configured to project an indicator 312 onto an area 410 occupied by the projected image on the projection panel 400. Referring to FIG. 2, the control device 310 includes three buttons 314 and three light emitters 316. Each of the buttons 314 is actuatable to activate one of the light emitters 316 to project the indicator 312 onto the occupied area 410 correspondingly. In this embodiment, the control device 310 projects three colored indicators corresponding to actuating of the three buttons 314. The colored indicators include a red indicator, a green indicator and a blue indicator.

The image processing module 320 is configured to capture an image of an object. In this embodiment, the image processing module 320 captures a first image of the display screen 102, and a second image of the occupied area 410. The image processing module 320 includes a focusing lens unit 321, an image sensor 322, a processing unit 323, a viewfinder 324, a dimension calculating unit 325 and a comparing unit 326.

The focusing lens unit 321 is configured to focus light from the object onto the image sensor 322. The focusing lens unit 321 is beneficially a wide-angle lens unit and an optical zoom lens unit.

The image sensor 322 such as a charge-coupled device (CCD) is configured to convert the light incident thereon into electrical signals. The image sensor 322 can be a semiconductor package selected from the group consisting of a ceramic leaded chip carrier (CLCC) package type image sensor, a plastic leaded chip carrier (PLCC) package type image sensor, and a chip scale package (CSP) type image sensor.

The processing unit 323 is configured to convert the electrical signals from the image sensor 322 into a digital image of the object, i.e., a digital resulting screen image, and control the viewfinder 324 to display the image. The viewfinder 324 may be a liquid crystal display.

The dimension calculating unit 325 is configured to calculate the dimensions of the display screen 102 and the dimensions of the occupied area 410 and compute a screen to projection ratio according to the dimensions of the occupied area 410 and the dimensions of the display screen 102. The dimension calculating unit 325 includes an auto-focus sub-unit 327, a pattern recognition sub-unit 328, and a calculating sub-unit 329.

The auto-focus sub-unit 327 is configured to receive the first image of the display screen 102 and the second image of the occupied area 410 from the processing unit 323, perform passive analysis of the first and second images and thereby determining correct focuses of the focusing lens unit for the display screen 102 and the occupied area 410. Once the correct focuses are determined, the auto-focus sub-unit 327 also can determine the distance from the image sensor 322 to the focusing lens unit 321 and the distances from the display screen 102 to the focusing lens unit 321 and from the occupied area 410 to the focusing lens unit 321.

The pattern recognition sub-unit 328 is configured to recognize a first area occupied by the display screen 102 in the first image and a second area occupied by the occupied area 410 in the second image after the images are in focus and determine the dimensions of the first area within the first image and the dimensions of the second area within the second image. In the embodiment, the first area and the second area are rectangular. The dimensions of the first area are the height and length of the first area, and the dimensions of the second area are the height and length of the second area. The pattern recognition sub-unit 328 can use many available methods, such as edge detection, to recognize the first area occupied by the display screen 102 and the second area occupied by the occupied area 410 in the first and second images, and determine the dimensions of the first area and the dimensions of the second area.

The calculating sub-unit 329 is configured to calculate the approximate dimensions of the display screen 102 and the approximate dimensions of the occupied area 410 according to ratios determined by the relationships between the distance from the display screen 102 to the focusing lens unit 321 and the distance from the occupied area 410 to the focusing lens unit 321, the distance from the image sensor 322 to the focusing lens unit 321, and the dimensions of the first area and the dimensions of the second area in the first and second captured images. In this embodiment, the display screen 102 and the occupied area 410 are rectangular. The dimensions of the display screen 102 are the height and length of the display screen 102, and the dimensions of the occupied area 410 are the height and length of the occupied area 410. Once the dimensions of the display screen 102 and the dimensions of the occupied area 410 are determined, the calculating sub-unit 329 further calculates the screen to projection ratio according to the dimensions of the occupied area 410 and the dimensions of the display screen 102.

After the dimensions of the display screen 102 and the dimensions of the occupied area 410 are calculated, the image processing module 320 is further configured to capture a video of the occupied area 410. The captured video contains consecutive images of the occupied area 410 at a predetermined rate, e.g., 60 images per second.

The pattern recognition sub-unit 328 is further configured to recognize the projected indicator 312 in the captured video. A recognition principle of the projected indicator 312 is same as those of the display screen 102 and the occupied area 410. The comparing unit 326 is configured to compare the relative positions of the projected indicator 312 in the two captured consecutive images in the video, thereby tracking the projected indicator 312 in the captured video.

The cursor controlling module 330 is configured to control movement of the cursor on the display screen 102 according to a track of the projected indicator 312 on the occupied area 410. Specifically, the cursor controlling module 330 controls the movement of the cursor according to the track of the indicator 312 and the screen to projection ratio. Therefore, the cursor controlling module 330 signals the computer 10 to move the cursor on the display screen 102 accordingly.

Further, the cursor controlling module 330 is configured to activate a cursor action according to the color of the indicator 312. For example, if the indicator 312 is a red indicator, a cursor action is activated as a left-click action of a mouse. If the indicator 312 is a green indicator, a cursor action is activated as a right-click action of the mouse. If the indicator 312 is a blue indicator, no cursor action is activated. The cursor controlling module 330 tells the computer 10 to perform corresponding commands according to the colored indicator. Thus, the presenter can present next to the projection panel 400 while conveniently controlling the cursor of the computer 10 without moving between the projection panel 400 and the computer 10.

Various components of the presentation system 100 such as the processing unit 323, the cursor controlling module 330, the dimension calculating unit 325 can be individual electrical elements, or alternatively integrated into a central control unit in the computer. The components can be connected to each other using an input/output (I/O) bus. Also, some units can be software modules written in a variety of computer languages such as C#, Visual C++, Visual BASIC, C++, and so on.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A presentation controlling system for controlling a cursor of a computer, the computer comprising a display screen to display the cursor and configured to output an image to a projector, the projector configured to project the image onto a projection panel, the presentation controlling system comprising:
a control device configured to project an indicator onto an area occupied by the projected image on the projection panel;
an image processing module configured to recognize the projected indicator, and to track the projected indicator on the occupied area; and
a cursor controlling module configured to control movement of the cursor on the display screen according to a track of the indicator on the occupied area, and to activate a cursor action according to the recognized indicator.

2. The system as claimed in claim 1, wherein the indicator is selected from the group consisting of a first colored indicator, a second colored indicator and a third colored indicator.

3. The system as claimed in claim 2, wherein the cursor action is activated as a left-click action of a mouse if the indicator is the first colored indicator.

4. The system as claimed in claim 3, wherein the cursor action is activated a right-click action of the mouse if the indicator is the second colored indicator.

5. The system as claimed in claim 4, wherein no cursor action is activated if the indicator is the third colored indicator.

6. The system as claimed in claim 1, wherein the image processing module is configured to capture a first image of the display screen and a second image of the occupied area, and comprises a focusing lens unit, an image sensor, and a processing unit, the image sensor configured to convert light directed by the focusing lens unit incident thereon into electrical signals, the processing unit configured to covert the electrical signals into an image of an object.

7. The system as claimed in claim 6, wherein the image processing module comprises a dimension calculating unit configured to calculate the dimensions of the display screen and the dimensions of the occupied area according to the first image and the second image and compute a screen to projection ratio according to the dimensions of the occupied area and the dimensions of the display screen.

8. The system as claimed in claim 7, wherein the dimensions of the display screen are the height and length of the display screen, and the dimensions of the occupied area are the height and length of the occupied area.

9. The system as claimed in claim 7, wherein the dimension calculating unit comprises an auto-focus sub-unit configured to receive the first image and the second image and to determine correct focuses for the display screen and the occupied area, the distance from the image sensor to the focusing lens unit and the distances from the display screen to the focusing lens unit and from the occupied area to the focusing lens unit.

10. The system as claimed in claim 9, wherein the dimension calculating unit further comprises a pattern recognition sub-unit, the pattern recognition sub-unit configured to recognize a first area occupied by the display screen in the first image and a second area occupied by the occupied area in the second image and to determine the dimensions of the first area within the first image and the dimensions of the second area within the second image.

11. The system as claimed in claim 10, wherein the dimensions of the first area are height and length of the first area, and the dimensions of the second area are height and length of the second area.

12. The system as claimed in claim 10, wherein the dimension calculating unit further comprises a calculating sub-unit, the calculating sub-unit configured to calculate the dimensions of the display screen and the dimensions of the occupied area according to ratios determined by the relationships between the distances from the display screen to the focusing lens unit and from the occupied area to the focusing lens unit, the distance from the image sensor to the focusing lens unit, and the dimensions of the first area in the first image and the dimensions of the second area in the second image and compute the screen to projection ratio according to the dimensions of the occupied area and the dimensions of the display screen.

13. The system as claimed in claim 12, wherein the image processing module is configured to capture a video of the occupied area and comprises a comparing unit, the captured video containing consecutive images of the occupied area at a predetermined rate, and the pattern recognition sub-unit is further configured to recognize the projected indicator in the captured video, and the comparing unit is configured to compare the relative positions of the projected indicator in the two consecutive captured images in the video, thereby tracking the projected indicator in the captured video.

14. A presentation system, comprising:
a computer configured to output an image, the computer comprising a display screen and a cursor displayed on the display screen;
a projector configured to project the image outputted by the computer onto a projection panel;
a control device configured to project an indicator onto an area occupied by the projected image on the projection panel;
an image processing module configured to recognize the projected indicator, and to track the projected indicator on the occupied area; and
a cursor controlling module configured to control movement of the cursor on the display screen according to a track of the indicator on the occupied area, and to activate a cursor action according to the recognized indicator.
